(19) United States
(12) Patent Application Publication
(10) Pub. No.: US 2001/0035677 A1
(43) Pub. Date: Nov. 1, 2001

(54) Method and apparatus for controlling a braking system of a vehicle

(76) Inventors: Peter Schafer, Braunschweig (DE); Dieter Maus, Hohenhameln (DE); Rudolph Heuer, Ribbesbuttel (DE)

Correspondence Address: BAKER & BOTTS, 30 ROCKEFELLER PLAZA, NEW YORK, NY, 10112

(21) Appl. No.: 09/853,014

(22) Filed: May 10, 2001

Related U.S. Application Data
(63) Continuation of application No. PCT/EP99/08299, filed on Oct. 30, 1999.

(30) Foreign Application Priority Data
Nov. 11, 1998 (DE) 198 52 064.6
Apr. 15, 1999 (DE) 199 17 046.0

(51) Int. Cl. B60T 8/44

(52) U.S. Cl. 303/114.1; 303/125

(57) ABSTRACT

A braking system for a vehicle is responsive to vehicle dynamic operating conditions to provide enhanced braking when vehicle instability is detected. In one version braking force as a function of brake pedal force is increased. In another version an actuator takes up free play in a brake clamping device. The system may additionally respond to operator controls indicating possible full braking action; such as rapid release of an accelerator.

### BACKGROUND OF THE INVENTION

This application is a continuation of application PCT/EP99/08299 filed Oct. 30, 1999. The invention relates to a method and apparatus for controlling a braking system of a vehicle

Shortening the braking distance of a motor vehicle is one of the most pressing problems in designing braking systems, since a large number of serious and sometimes fatal accidents could be avoided if the braking distance were shortened by just a few meters.

One method for shortening the braking distance in critical driving situations, wherein an external force provides increased braking force when the operating speed of the foot pedal exceeds a threshold value, has already been disclosed in DE 4,028,290 C1. In that method, it is assumed that there are cases in which, in panic or emergency braking, the driver applies the pedal rapidly, but fails to apply sufficient force to the pedal. In this situation, the driver is supported by the external force and a braking force is thereby created which is greater than the braking force that, in normal operation of the pedal, would correspond to the pedal force.

The basic principle of this and similar methods consists in detecting, by means of suitable sensors, a foot motion speed or a pedal speed, of either the gas or the brake pedal and, when a threshold value is exceeded, increasing the brake pressure by means of an external force. Since modern motor vehicles customarily have braking force boosters to provide “power brakes”, the increase in brake pressure is effected by variation in the transfer characteristic of the braking force booster.

To avoid undesired engagement of the increased force, a variety of methods and devices have been proposed, all of which have in common distinguishing between rapid foot motion for intended braking or for intended gear shift. In this connection, reference is made to DE 4,430,461, in which a driver-adaptive learning method is proposed.

DE 196 07 048 discloses a brake system wherein upon detection of a given pedal speed the brake is preloaded, so that the free play of the brake is shifted toward zero. There, it is additionally proposed that the brake may optionally be preloaded in such a way that a brake pressure is already generated without actuation of the brake pedal.

Further, DE 4,415,613 discloses a two-circuit hydraulic brake system for a road vehicle that is equipped with an antilocking brake system (ABS) working according to the feedback principle, as well as with a means for control of dynamics of vehicle movement (DVM), which works according to the principle of controlling, by automatic electronically controlled activation of one or more wheel brake(s), longitudinal and lateral slipping of the vehicle wheels within tolerable limits, and providing dynamic stability of the vehicle as a whole. The system further provides for automatic release of full braking when the driver actuates the brake pedal at a speed that is greater than a threshold value, wherein

a) the brake system has a front axle/rear axle brake circuit distribution, and a static main cylinder, actuable by means of a brake pedal via a braking force booster is provided as brake pressure control device, with pressure outputs individually assigned to the brake circuits;

b) selection of the wheel brake(s) to be activated in control operation of the dynamics of vehicle movement is effected by selective control of the brake pressure control valves of the antilocking brake system;

c) there is provided a pedal-position sensor that generates characteristic electrical output signals for the respective instantaneous position of the brake pedal, which are capable of being processed by an electronic processor provided for control of the respective control operation DVM and/or ABS—as set-value information for the vehicle delay desired by the driver, and

d) there is provided a pressure sensor that generates characteristic electrical output signals for the instantaneous values of the brake pressure coupled into the front axle brake circuit which are capable of being processed by the electronic control unit as brake pressure actual-value information signals;

e) the brake-pressure control device is controllable by pedal-controlled pressurization of a drive pressure chamber of the braking force booster, as well as by valve-controlled pressurization, automatically releasable by output signals of the electronic control unit, of the drive pressure chamber of the braking force booster in brake-pressure supply operation;

f) for supplementary or exclusive brake-pressure supply to the front axle brake circuit of the brake system, there is provided a valve-controlled auxiliary cylinder, capable of being acted upon and again released by the output pressure of an auxiliary pressure source, by means of which, in normal—driver controlled—as well as in automatically controlled partial or full braking, brake fluid is displaceable into the brake circuit connected to the primary pressure output of the brake-pressure control device;

g) the auxiliary cylinder is designed in the manner of a pressure intensifier whose maximum output pressure valve is sized sufficiently great for the use of high friction coefficients in control operation of the dynamics of vehicle movement;

h) the quantity of brake fluid displaceable into the front axle brake circuit by means of the auxiliary cylinder is controllable in a comparative processing of the output signals of the pedal-position sensor with the output signals of the pressure sensor in predeterminable monotone correlation.

This device, is disadvantageous because automatically initiated braking operations not only lead to problems of acceptance for the motor vehicle, but may also unintentionally lead to dangerous situations in noncritical operation.

DE 4,302,541 discloses an automatic brake system for a motor vehicle having a means for detecting a distance and a relative speed between the vehicle and an obstacle, a means for establishing a first and a second region on the basis of the detected distance and relative speed, for operating an automatic brake that brakes respective wheels when the second region is established, where the automatic brake has a vacuum-type booster and a means for increasing the low pressure of the automatic brake before the second region is established. Under selected test conditions, when an obstacle is identified, automatic brakes of this kind generate the shortest braking distance, theoretically as well as practically. It is accepted in principle, however, that such automatic brakes do not yet detect fill braking situations reliably enough. An additional disadvantage is the complicated technology for detecting and evaluating obstacles, so that such devices are not available for mass production in the foreseeable future.

It is an object of the invention to provide a method and apparatus for controlling a braking system of a vehicle by means of which the braking distance of a vehicle can be simply and reliably reduced, when potential fill braking by the driver of the vehicle takes place.

### SUMMARY OF INVENTION

According to a first aspect of the invention, a braking system of a vehicle is provided with a device for adjusting or varying the braking effect of the brake system. The dynamic condition of the vehicle is monitored and analyzed to detect an unstable vehicle condition, for example, a risk of swerving or skidding of the vehicle. The boosting of the braking effect at a predetermined pedal force is increased in response to detection of an unstable condition.

After the end of the unstable condition of the dynamics of vehicle movement, the boosting of the braking effect is returned to the normal level originally set.

The boosting of the braking effect of the brake system as a function of pedal force on the brake pedal may be provided by a braking force booster having a variable booster characteristic. Variation of the characteristic may be effected for example by switching between at least two predetermined characteristics of breaking force as a function of brake pedal force.

Another possibility is a device which can automatically vary braking force, for example a device for controlling the dynamics of vehicle movement, may be provided.

According to another aspect of the invention, shortening of the braking distance can be obtained by controlling the actuating device for the clamping device of a brake system, that presses two friction elements together for braking of a vehicle after overcoming a free play. Upon detection of an unstable dynamic condition respecting the vehicle movement, the actuating device can be controlled in such a way that the free play is overcome. In other words, the brake is preloaded.

According to one embodiment of the invention, the intention of the operator to apply full braking may be determined. The full braking intention can be used for boosting of the braking effect as a function of pedal force and/or preload the braking devices of the individual vehicle wheels.

Detection of intended full braking may be effected in a variety of ways, such as by monitoring the vehicle accelerator, brake pedal or clutch such as by detecting a rapid withdrawal motion of the accelerator. Here, the withdrawal speed of the gas pedal may be used as a determinable parameter.

The invention provides an appreciable shortening of the braking distance in driving situations in which full braking is foreseeable by the actions of the driver of the vehicle, without exposure to the risk of false automatic braking.

The invention is described in detail below by means of examples.

### BRIEF DESCRIPTION OF THE DRAWINGS

FIG. 1, is a block diagram of a device according to the invention with an apparatus for adjusting the boosting of the braking force.

FIG. 2, is a block diagram of a device according to the invention with an apparatus for adjusting the boosting of the braking force and a device for detecting potential intended full braking.

FIG. 3, is a block diagram of a device according to the invention for preloading a brake clamping device.

### DESCRIPTION OF THE INVENTION

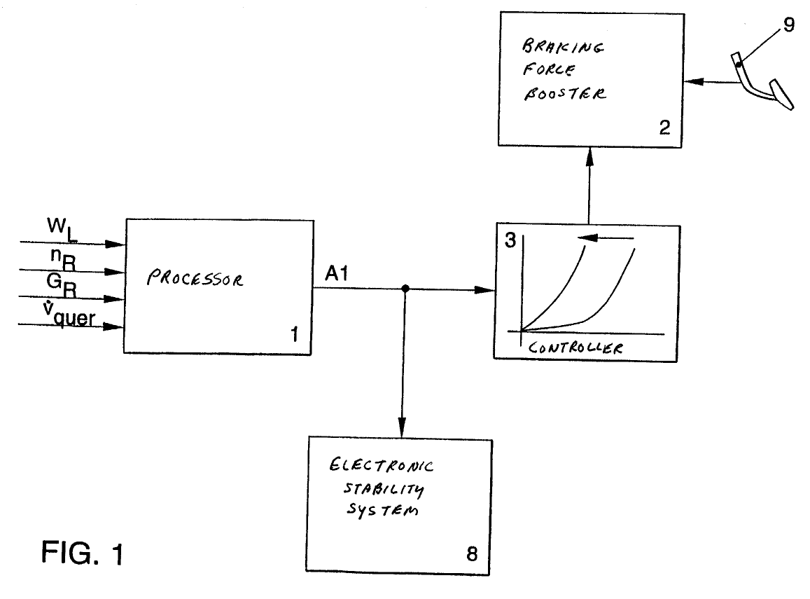

A first example of a device according to the invention, shown in FIG. 1, has a processor 1 for monitoring vehicle dynamic conditions and detecting a condition of vehicle instability. Processor 1 receives signals from detectors, such as steering wheel angle W₁ rotational wheel speed M_{R}, yaw rate G_{R} and transverse acceleration \dot{V}_{quer}, and provides an output signal A1, which may be provided to by an Electronic Stability (ESP) control unit 8, for vehicle movement dynamics control, as well as to a brake controller 3. Brake controller 3 operates to control the operation of braking force booster 2, which increases the braking force supplied by the brake pedal 8. Controller 3 provides for variation in the braking force applied to the vehicle wheels as a function of applied brake pedal force.

In one embodiment the braking force booster 2 has a plurality of boosting characteristics, which may be selected by controller 3 in response to signal Al to vary the boosting of the braking force of the brake system as a function of pedal force on the brake pedal 9.

For detecting an unstable condition respecting the dynamics of vehicle movement, the processor 1 is supplied with a great variety of sensor signals, for example of the steering wheel angle w_{L}, the rotational speed n_{R} of the vehicle wheels, the yaw rate G_{R} and the transverse acceleration \dot{V}_{quer}, of the vehicle. An exact description of the determination of an unstable condition respecting the dynamics of vehicle movement in conjunction with vehicle movement dynamics control is disclosed in Audi's self-study program 204 “Electronic Stability Program.”

If the processor 1 detects from the sensor signals that an unstable situation may arise and intervention may be necessary, it sends a corresponding output signal A1 to the device 8 and the brake controller 3. The controller 3 changes the booster 2 to a characteristic of the braking force as a function of pedal force such that the boosting of the brake system, at like pedal force on the brake pedal 9, is increased. If the processor 1 then detects from the sensor signals supplied to it that an unstable condition respecting the dynamics of vehicle movement no longer exists, the controller 3 returns the brake force booster 2 to its original boosting characteristic.

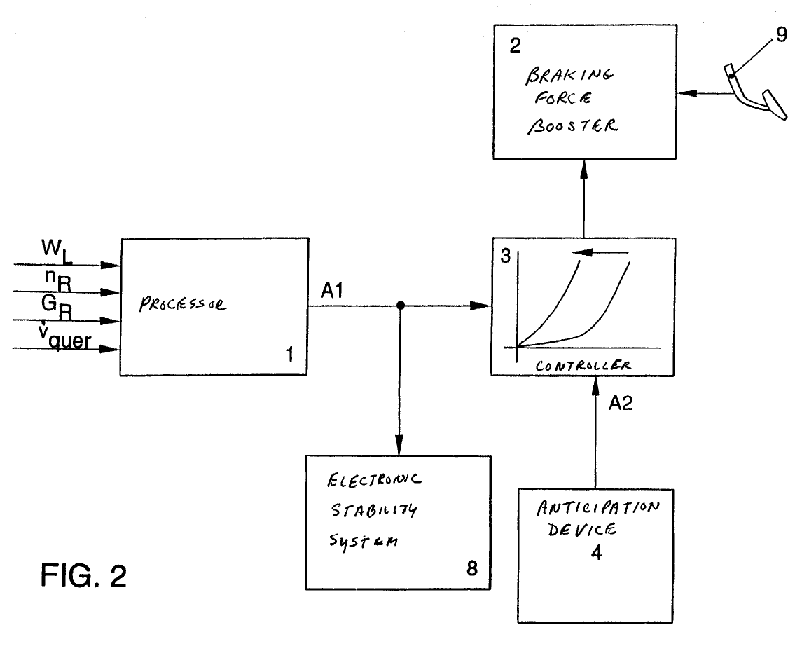

The braking system shown in FIG. 2 differs from the system shown in FIG. 1 only in that the controller 3 for the braking force booster 2, is additionally supplied with the output signal A2 of a device 4 for detecting potential intended full braking by the driver of the vehicle. Device 4 may, for example, be a sensor for detecting the position of an adjusting member for determining the power output of the drive engine of the vehicle, such as the accelerator or clutch, or alternatively a device for detecting rapid release of the accelerator., If the controller 3 determines from the output signal A2 that the driver of the vehicle may execute full braking, it likewise switches the brake force booster 2 to a characteristic of greater boosting, whereby support of the driver during the full braking action is obtained. This function may take place regardless of whether a critical state respecting the dynamics of vehicle movement exists or not.

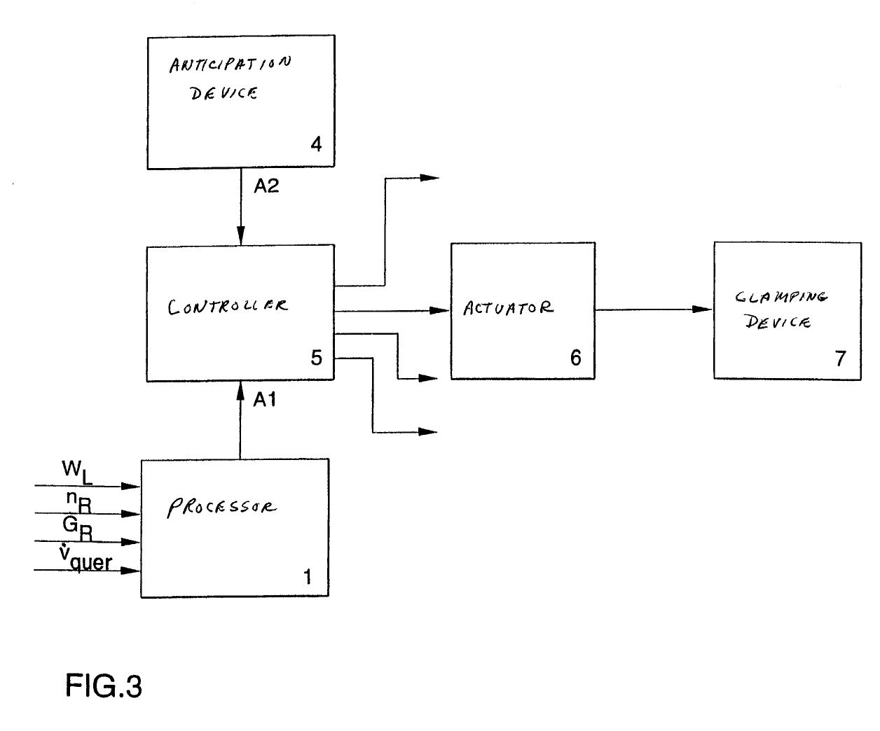

The system shown in FIG. 3 likewise has a processor 1 for detecting an unstable condition of the vehicle respecting the dynamics of vehicle movement, whose output signal A1 is supplied to a controller 5. The controller 5 controls an actuator 6 for each vehicle wheel. The actuator 6 actuates a clamping device 7 which, for braking the respective vehicle wheel after overcoming free play, presses two friction elements together.

Now if the processor 1 detects an unstable condition respecting the dynamics of vehicle movement, the controller 5 drives the actuator 6 so that the free play of the clamping device 7 is overcome before the brake action actually produced by the driver of the vehicle, so that the brake is preloaded.

In addition, a device 4 for determining potential intended full braking, whose output signal A2 is likewise supplied to the controller 5, may also be provided in the FIG. 3 system.

We claim:

1. A method for controlling a brake system of a vehicle wherein braking effect on the vehicle wheels is a function of brake pedal force exerted by the operator, said braking effect being enhanced by an adjustable braking force booster, comprising:
detecting dynamic conditions of operation of said vehicle;
analyzing said dynamic conditions to detect a condition of vehicle instability; and
increasing the force boosting effect of said braking force booster when said analysis indicates condition of vehicle instability.

2. A method according to claim 1 wherein said force boosting effect of said braking force booster is returned to an original condition where said analysis no longer indicates a condition of vehicle instability.

3. A method according to claim 1 wherein said adjustable braking force booster provides a first normal braking force as a function of brake pedal pressure for normal vehicle operation and a second higher braking force as a function of brake pedal pressure when said analysis indicates a condition of vehicle instability.

4. A method as specified in claim 3 wherein said condition of vehicle instability causes said braking force booster to switch to said second braking force as a function of brake pedal pressure.

5. A method according to claim 1 further comprising monitoring operator use of at least one vehicle control to detect a condition wherein the operator may apply full braking and increasing the force boosting effect of said braking force booster when said monitoring indicates a condition wherein said operator may apply full braking.

6. A method as specified in claim 5 wherein said monitoring comprises monitoring the operator's use of the accelerator.

7. A method as specified in claim 6 wherein said condition wherein said operator may apply full braking is detected by rapid release of said accelerator.

8. A method for controlling a braking system of a vehicle having at least one clamping device for braking a vehicle, and an actuator for moving said clamping device into clamping engagement, comprising:
detecting dynamic conditions of operation of said vehicle;
analyzing said dynamic conditions to detect a condition of vehicle instability; and
in response to detection of a condition of vehicle instability operating said actuator to overcome free play of said clamping device.

9. A method according to claim 8 further comprising monitoring operator use of at least one vehicle control to detect a condition wherein the operator may apply full braking and operating said actuator to overcome free play of said clamping device when said monitoring indicates a condition wherein said operator may apply full braking.

10. A method as specified in claim 9 wherein said monitoring comprises monitoring the operator's use of the accelerator.

11. A method as specified in claim 10 wherein said condition wherein said operator may apply full braking is detected by rapid release of said accelerator.

12. A braking system for a vehicle comprising:
a brake pedal for operation by a vehicle operator for applying braking force;
a braking force booster for increasing said braking force, said booster providing a first normal braking force as a function of force applied to said brake pedal and change said normal braking force as a function of force applied to said brake pedal; and
a processor responsive to supplied signals representing dynamic conditions of operation of said vehicle, said processor being programmed to analyze said dynamic conditions and provides said control signal to said booster to cause said booster to change braking force when said dynamic conditions indicate a condition of vehicle instability.

13. A braking system as specified in claim 12 wherein said braking force change is an increase of braking force as a function of force applied to said brake pedal.

14. A braking system as specified in claim 12 wherein said braking force has variable braking force as a function of said control signal.

15. A braking system as specified in claim 14 wherein said braking force booster has a second braking force as a function of force applied to said brake pedal, and wherein said control signal causes said booster to change from said first to said second braking force.

16. A braking system as specified in claim 12 wherein said processor is a part of one electronic stability system.

17. A braking system as specified in claim 12 further including a device for supplying said processor with signals representing a vehicle operator's use of at least one vehicle control, and wherein said processor is responsive to said vehicle control signals to detect an operator condition wherein the vehicle operator may apply full braking, and wherein said processor provide said control signal in response to said operator condition.

18. A braking system as specified in claim 17 wherein said vehicle control comprises an accelerator.

19. A braking system as specified in claim 18 wherein said processor detects said operator condition by rapid release of said accelerator.

20. A braking system for a vehicle comprising:
a brake pedal for operation by a vehicle operator for applying braking force;
at least one clamping device, responsive to an actuator, for applying said braking force to said vehicle;
an actuator, responsive to said braking force and a control signal for operating said clamping device, wherein said control signal operator said actuator to overcome free play of said clamping device; and
a processor responsive to supplied signals representing dynamic conditions of operation of said vehicle, said processor being programmed to analyze said dynamic conditions and provide said control signal to said actuator when said dynamic conditions indicate a condition of vehicle instability.

21. A braking system as specified in claim 20 wherein said processor is a part of one electronic stability system.

22. A braking system as specified in claim 20 further including a device for supplying said processor with signals representing a vehicle operator's use of at least one vehicle control, and wherein said processor is responsive to said vehicle control signals to detect an operator condition wherein the vehicle operator may apply fill braking, and wherein said processor provide said control signal in response to said operator condition.

23. A braking system as specified in claim 22 wherein said vehicle control comprises an accelerator.

24. A braking system as specified in claim 23 wherein said processor detects said operator condition by rapid release of said accelerator.
